(19) United States
(12) Patent Application Publication
(10) Pub. No.: US 2022/0315709 A1
(43) Pub. Date: Oct. 6, 2022

(54) PROCESS FOR PRODUCING SIOC-BONDED, LINEAR POLYDIALKYLSILOXANE-POLYETHER BLOCK COPOLYMERS AND USE THEREOF

(71) Applicant: Evonik Operations GmbH, Essen (DE)

(72) Inventors: Thomas Reibold, Herten (DE); Matthias Lobert, Essen (DE); Michael Klostermann, Essen (DE); Michelle Eckhoff, Essen (DE)

(21) Appl. No.: 17/706,552

(22) Filed: Mar. 28, 2022

(30) Foreign Application Priority Data
Mar. 30, 2021 (EP) 21165763

(51) Int. Cl. C08G 77/46; C08L 75/08; C08J 9/30

(52) U.S. Cl. CPC C08G 77/46; C08L 75/08; C08J 9/30; C08J 2375/08; C08J 2483/12

(57) ABSTRACT

Process for producing SiOC-bonded, linear polydialkylsiloxane-polyoxyalkylene block copolymers comprising repeating (AB) units comprising the reaction of a linear, α,ω-(SiH)-functional polydialkylsiloxane (a) with a linear α,ω-(OH)-functional polyoxyalkylene (b) using one or more compounds of elements of main group III and/or the 3rd transition group as catalyst (c), optionally in the presence of a solvent (d), wherein the two reactants (a) and (b) preferably in equimolar amounts and with controlled hydrogen evolution are reacted to quantitative SiH conversion.

### FIELD OF THE INVENTION

The present invention is in the fields of silicone chemistry and polyurethane chemistry and relates to a process for producing SiOC-bonded, linear polydialkylsiloxane-polyoxyalkylene block copolymers comprising repeating (AB) units and to the use thereof in the production of polyurethanes.

### BACKGROUND OF THE INVENTION

The process principle for producing SiOC-bonded polydialkylsiloxane-polyoxyalkylene block copolymers by reaction of SiH-functional polyorganosiloxanes with alcohols/OH-functional polyoxyalkylene polymers using one or more compounds of elements of main group III and/or the 3rd transition group as catalyst is known in principle from EP 1460099 B1. Described therein is a preferred reaction of an at least equimolar to 3-fold excess of alcohol groups to SiH groups. This process was used to react linear and/or branched polyorganosiloxanes with alcohols and/or OH-functional polyoxyalkylenes.

A process for producing SiOC-bonded, linear polydimethylsiloxane-polyether block copolymers comprising repeating (AB) units is also known from EP 1935922 B1, wherein the thus-produced polydimethylsiloxane-polyoxyalkylene block copolymers are used as interface-active additives for producing polyurethane foams, in particular for producing mechanically foamed polyurethane foams. EP 1935922 B1 describes the reaction of linear α,ω-(SiH)-functional polydimethylsiloxanes comprising linear α,ω-(OH)-functional polyether diols using one or more compounds of elements of main group III and/or the 3rd transition group as catalyst. This process which may be performed neat or in the presence of solvent has the essential feature that the (SiH) functions of the polydimethylsiloxane relative to the (OH) functions of the polyoxyalkylene are employed in a molar excess of preferably 1.1 to 2.0 and the reaction is continued until (SiH) groups can no longer be detected by gas volumetric means.

However, the use in excess of the polysiloxane which is much more costly than the polyether diol component and the subsequent lengthy postreaction for quantitative reaction of the excess (SiH) groups is disadvantageous from an economic standpoint.

### SUMMARY OF THE INVENTION

It was accordingly an object of the present invention to provide a simple, economically viable and stable process which makes it possible to produce SiOC-bonded, linear polydialkylsiloxane-polyoxyalkylene block copolymers comprising repeating (AB) units reproducibly and with an improved profile of properties.

It has surprisingly been found that the use of preferably equimolar amounts of (SiH) functions of a linear, α,ω-(SiH)-functional polydialkylsiloxane relative to the (OH) functions of a linear α,ω-(OH)-functional polyoxyalkylene in conjunction with controlled hydrogen evolution makes it possible to provide particularly high molecular weight products which represent qualitatively higher quality products than those obtainable by the process published in EP 1935922 B1. Controlled hydrogen evolution may be brought about through controlled addition. The process according to the invention is moreover markedly more stable and less prone to failure.

The invention provides a process for producing SiOC-bonded, linear polydialkylsiloxane-polyoxyalkylene block copolymers comprising repeating (AB) units comprising reaction of a linear, α,ω-(SiH)-functional polydialkylsiloxane (a) with a linear α,ω-(OH)-functional polyoxyalkylene (b) using one or more compounds of elements of main group III and/or the 3rd transition group as catalyst (c), optionally in the presence of a solvent (d), wherein the two reactants (a) and (b) preferably in equimolar amounts and with controlled hydrogen evolution are reacted to quantitative SiH conversion.

Reactant (a) is in the context of the present invention: linear α,ω-(SiH)-functional polydialkylsiloxane.

Reactant (b) is in the context of the present invention: linear α,ω-(OH)-functional polyoxyalkylene.

The invention further provides the SiOC-bonded, linear polydialkylsiloxane-polyether block copolymers comprising repeating (AB) units produced by the process according to the invention.

The invention further provides for the use of the SiOC-bonded, linear polydialkylsiloxane-polyether block copolymers comprising repeating (AB) units produced by the process according to the invention as interface-active additives for producing polyurethane foams, in particular for producing beaten polyurethane foams.

### BRIEF DESCRIPTION OF THE DRAWINGS

FIG. 1 shows the profile of the gas volume liberated by the progress of the reaction as a function of the added siloxane mass for example 6 from the experimental part, in each case as the target and actual conversion.

FIG. 2 shows the profile of the gas volume liberated by the progress of the reaction as a function of the added siloxane mass for example 7 from the experimental part, in each case as the target and actual conversion.

FIG. 3 shows the profile of the gas volume liberated by the progress of the reaction as a function of the added siloxane mass for example 8 from the experimental part, in each case as the target and actual conversion.

FIG. 4 shows the difference between the target and actual conversion in % as a function of the added siloxane mass for examples 6 to 8 from the experimental part.

### DETAILED DESCRIPTION OF THE INVENTION

The linear α,ω-(SiH)-functional polydialkylsiloxanes employed in the process according to the invention are known per se. They may be subjected to (preferably acidic) equilibration in known fashion by any desired prior art processes.

They preferably have weight average molecular weights between about 650 and 6500 g/mol, preferably between 800 and 1500 g/mol, in particular between about 1000 to 1200 g/mol. This corresponds to a preferred embodiment of the invention. The determination of the average molecular weights is based on the known methods of GPC analysis.

They moreover preferably have SiH values between 0.3 and 3.0 mol/kg, preferably between 1.3 and 2.6 mol/kg, in particular between 1.6 and 2.1 mol/kg. Determining the amount of substance of SiH units of the linear α,ω-(SiH)-functional polydialkylsiloxanes is based on the known method of alkaline-catalysed SiH value determination.

It is preferable to employ linear α,ω-(SiH)-functional polydialkylsiloxanes of general formula (I):

M′-Dₐ-M′ Formula (I)

wherein
M′=[HR¹₂SiO_{1/2}]
D=[R¹₂SiO_{2/2}]
a=8-100, preferably 10-60, especially preferably 12-40,
R¹=independently at each occurrence identical or different hydrocarbon radicals having 1-20 carbon atoms, preferably methyl, ethyl, propyl or butyl, especially preferably methyl.

The linear α,ω-(OH)-functional polyoxyalkylenes used in the process according to the invention (hereinbelow for the purposes of the present invention also referred to simply as “polyether diols”) are likewise known per se. They may be produced by any desired prior art processes. They preferably conform to general formula (II):

HO—(CₙH₍₂ₙ₋ₘ₎R²ₘO—)_{b}—H Formula (II)
b=1-200, preferably 10-100, especially preferably 25-60,
n=2-4,
m=0 or 1,
R²=independently at each occurrence identical or different hydrocarbon radicals having 1-12 carbon atoms, preferably methyl, ethyl, propyl or butyl, especially preferably methyl or ethyl.

It is preferable when the polyether diols are addition products of at least one alkylene oxide selected from the group of ethylene oxide, propylene oxide, butylene oxide, dodecene oxide and/or tetrahydrofuran onto difunctional starters such as for example water, ethylene glycol or propylene glycol.

The polyether diols are preferably constructed from at least two monomer units, especially preferably from ethylene oxide and propylene oxide.

The polyether diols preferably consist substantially of oxyethylene units or oxypropylene units, preference being given to mixed oxyethylene and oxypropylene units having an oxyethylene proportion of about 25% to 70% by weight and an oxypropylene proportion of 70% to 25% by weight based on the total content of oxyalkylene units.

The oxyethylene units or oxypropylene units may thus have a random or blockwise construction, preferably a blockwise construction.

The weight-average molecular weight M_{w} of each polyether diol is preferably between about 600 and 10 000 g/mol, preferably 1000 to 5000 g/mol, especially preferably 1500 to 3500 g/mol. Determination of average molecular weights is based on the known methods of OH number determination.

The molar ratio of linear α,ω-(SiH)-functional polydialkylsiloxane to linear α,ω-(OH)-functional polyoxyalkylene preferably employed in the process according to the invention is in the equimolar range. This is to be understood as meaning the use of preferably equimolar amounts of (SiH)-functions of the linear, α,ω-(SiH)-functional polydialkylsiloxane relative to the (OH)-functions of the linear α,ω-(OH)-functional polyoxyalkylene.

When in the context of the present invention reference is made to equimolar ratios or equimolar amounts of the two reactants (a) and (b), then this is in the context of the present invention to be understood as very specifically encompassing the range from 0.9 to 1.10, preferably 0.98 to 1.02, of linear α,ω-(SiH)-functional polydialkylsiloxane to linear α,ω-(OH)-functional polyoxyalkylene. This ratio is in particular very precisely equimolar, i.e. 1 to 1.

The total siloxane block proportion (A) in the SiOC-bonded, linear polydialkylsiloxane-polyoxyalkylene block copolymer having repeating (AB) units is preferably between 20% and 50% by weight, in particular 25% to 30% by weight, and the proportion of polyoxyalkylene blocks (B) is preferably between 80% and 50% by weight, preferably 75% to 70% by weight. It is preferable when the block copolymer has an average weight-average molecular weight M_{w} of at least 10 000 g/mol to about 250 000 g/mol, preferably 15 000 g/mol to about 225 000 g/mol, in particular 20 000 g/mol to about 200 000 g/mol. The determination of the average molar masses is based on the known methods of GPC analysis.

Depending on the application and desired product properties the process may be performed in the presence or absence of solvent as desired.

If particularly high molecular weight and thus particularly high viscosity SiOC-bonded copolymers are produced, the use of a solvent is particularly advantageous.

Advantageously employable solvents are for example alkanes, isoalkanes, cycloalkanes and/or alkylaromatics.

Advantageously employable alkanes are for example n-hexane, n-heptane, n-octane, n-nonane, n-decane, n-undecane and/or n-dodecane.

Advantageously employable cycloalkanes are for example cyclohexane, methylcyclohexane, cycloheptane, cyclooctane, cyclononane, cyclodecane, cycloundecane, cyclododecane and/or decalin.

Advantageously employable alkylaromatics are toluene, xylene, cumene, n-propylbenzene, ethylmethylbenzene, trimethylbenzene, solvent naphtha and/or any alkylbenzenes available on a large industrial scale.

It is preferable to employ high-boiling solvents having boiling points >120° C., especially preferably high-boiling alkylbenzenes.

The choice of the type and amount of the optional solvent depends on the specific application and may be varied over wide ranges.

For the purposes of particularly good product quality and particularly good efficiency of the process, in the context of a preferred embodiment of the invention it is preferable to employ between 40% by weight and 70% by weight of solvent based on the sum of the amounts of the reactants (a), (b) and the amount of solvent (c), especially preferably between 50% by weight and 65% by weight.

In the context of a preferred embodiment of the invention the reaction temperature for producing the block copolymers according to the invention is preferably 60° C. to 140° C., especially preferably 100° C. to 120° C.

The catalysts preferably employable in the process according to the invention in the context of a preferred embodiment of the invention are Lewis-acidic compounds of elements of main group III, in particular boron-containing and/or aluminium-containing compounds of elements.

Preferred Lewis-acidic compounds of elements of the 3rd transition group are especially scandium-containing, yttrium-containing, lanthanum-containing and/or lanthanoid-containing Lewis acids. According to the invention the compounds of elements of main group III and/or the 3rd transition group are particularly preferably employable as halides, alkyl compounds, fluorine-containing, cycloaliphatic and/or heterocyclic compounds.

A preferred embodiment of the invention provides that fluorinated and/or unfluorinated organoboron compounds are employed as catalysts, especially those selected from: (C₅F₄)(C₆F₅)₂B; (C₅F₄)₃B; (C₆F₅)BF₂; BF(C₆F₅)₂; B(C₆F₅)₃; BCl₂(C₆F₅); BCl(C₆F₅)₂; B(C₆H₅)(C₆F₅)₂; B(Ph)₂(C₆F₅); [C₆H₄(mCF₃)]₃B, [C₆H₄(pOCF₃)]₃B; (C₆F₅)B(OH)₂; (C₆F₅)₂BOH; (C₆F₅)₂BH; (C₆F₅)BH₂; (C₇H₁₁)B(C₆F₅)₂; (C₈F₁₄B)(C₆F₅); (C₆F₅)₂B(OC₂H₅); (C₆F₅)₂B—CH₂CH₂Si(CH₃)₃;

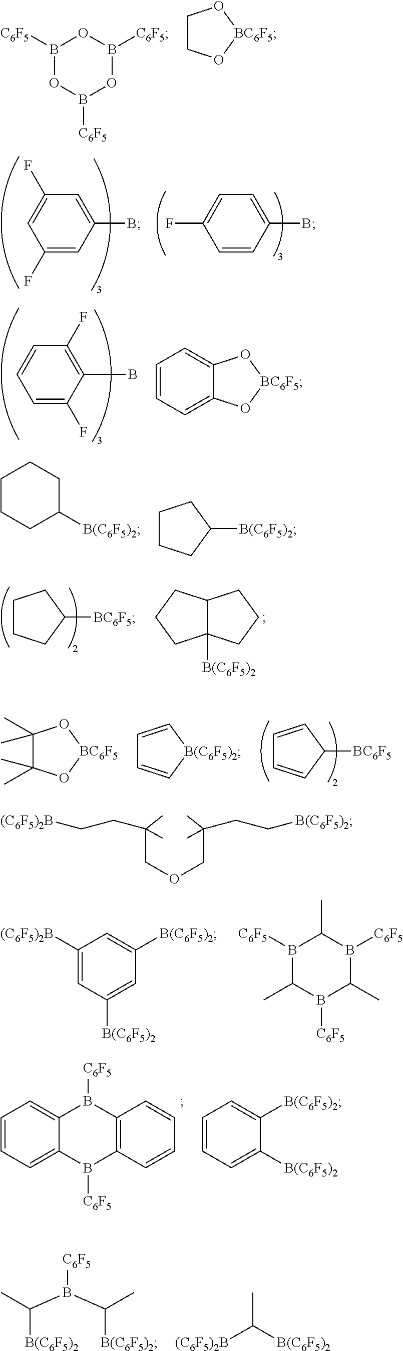

preferably employable catalysts include in particular tris(perfluorotriphenylborane) [1109-15-5], boron trifluoride etherate [109-63-7], borane triphenylphosphine complex [2049-55-0], triphenylborane [960-71-4], triethylborane [97-94-9] and boron trichloride [10294-34-5], tris(pentafluorophenyl)boroxine (901) [223440-98-0], 4,4,5,5-tetramethyl-2-(pentafluorophenyl)-1,3,2-dioxaborolane (901) [325142-81-2], 2-(pentafluorophenyl)-1,3,2-dioxaborolane (9Cl) [336880-93-4], bis(pentafluorophenyl)cyclohexylborane [245043-30-5], di-2,4-cyclopentadien-1-yl(pentafluorophenyl)borane (901) [336881-03-9], (hexahydro-3a(1H)-pentalenyl)bis(pentafluorophenyl)borane (901) [336880-98-9], 1,3-[2-[bis(pentafluorophenyl)boryl]ethyl]tetramethyldisiloxane [336880-99-0], 2,4,6-tris(pentafluorophenyl)borazine (7Cl, 8Cl, 9Cl) [1110-39-0], 1,2-dihydro-2-(pentafluorophenyl)-1,2-azaborine (9Cl) [336880-94-5], 2-(pentafluorophenyl)-1,3,2-benzodioxaborole (9Cl) [336880-96-7], tris(4-trifluoromethoxyphenyl)borane [336880-95-6], tris(3-trifluoromethylphenyl)borane [24455-00-3], tris(4-fluorophenyl)borane [47196-74-7], tris(2,6-difluorophenyl)borane [146355-09-1], tris(3,5-difluorophenyl)borane [154735-09-8], methyliumtriphenyltetrakis(pentafluorophenyl)borate [136040-19-2] and/or N,N-dimethylaniliniumtetrakis(pentafluorophenyl)borate and mixtures of the abovementioned catalysts.

A further preferred embodiment of the invention provides that fluorinated and/or unfluorinated organoaluminium compounds are employed as catalysts, especially those selected from:

AlCl₃ [7446-70-0], aluminium acetylacetonate [13963-57-0], AlF₃ [7784-18-1], aluminium trifluoromethanesulfonate [74974-61-1], di-iso-butylaluminium chloride [1779-25-5], di-iso-butylaluminium hydride [1191-15-7] and/or triethylaluminium [97-93-8] and mixtures thereof.

A further preferred embodiment of the invention provides that fluorinated and/or unfluorinated organoscandium compounds are employed as catalysts, especially those selected from:

Scandium(III) chloride [10361-84-9], Scandium(III) fluoride [13709-47-2], Scandium(III) hexafluoroacetylacetonate [18990-42-6], Scandium(III) trifluoromethanesulfonate [144026-79-9] and/or tris(cyclopentadienyl)scandium [1298-54-0] and mixtures thereof.

A further preferred embodiment of the invention provides that fluorinated and/or unfluorinated organoyttrium compounds are employed as catalysts, especially those selected from:

tris(cyclopentadienyl)yttrium [1294-07-1], yttrium(III) chloride [10361-92-9], yttrium(III) fluoride [13709-49-4], yttrium(III) hexafluoroacetylacetonate [18911-76-7] and/or yttrium(III) naphthenate [61790-20-3] and mixtures thereof.

A further preferred embodiment of the invention provides that fluorinated and/or unfluorinated organolanthanum compounds are employed as catalysts, especially those selected from: lanthanum(III) chloride [10099-58-8], lanthanum(III) fluoride [13709-38-1], lanthanum(III) iodide [13813-22-4], lanthanum(III) trifluoromethanesulfonate [52093-26-2] and/or tris(cyclopentadienyl)lanthanum [1272-23-7] and mixtures thereof.

A further preferred embodiment of the invention provides that fluorinated and/or unfluorinated organolanthanoid compounds are employed as catalysts, especially those selected from: cerium(III) bromide [14457-87-5], cerium(III) chloride [7790-86-5], cerium(III) fluoride [7758-88-5], cerium(IV) fluoride [60627-09-0], cerium(III) trifluoroacetylacetonate [18078-37-0], tris(cyclopentadienyl)cerium [1298-53-9], europium(III) fluoride [13765-25-8], europium(II) chloride [13769-20-5], praesodymium(III) hexafluoroacetylacetonate [47814-20-0], praesodymium(III) fluoride [13709-46-1], praesodymium(III) trifluoroacetylacetonate [59991-56-9], samarium(III) chloride [10361-82-7], samarium(III) fluoride [13765-24-7], samarium(III) naphthenate [61790-20-3], samarium(III) trifluoroacetylacetonate [23301-82-8], ytterbium(III) fluoride [13760-80-8], ytterbium(III) trifluoromethanesulfonate [54761-04-5] and/or tris(cyclopentadienyl)ytterbium [1295-20-1] and mixtures thereof.

The catalysts are preferably employed in amounts of 0.01% to about 0.2% by weight, in particular 0.03% to 0.10% by weight, based on the sum of the amount of the reactants (a) and (b). The catalyst(s) may be employed in homogeneous form or in the form of heterogeneous catalyst(s). The catalyst(s) may be added in dissolved or suspended form. The catalyst may advantageously be suspended or dissolved in a small portion of the solvent or the polyether diol and added, especially preferably may be added dissolved in the solvent.

In a preferred embodiment of the process according to the invention the polyether diol is initially charged and dried under vacuum at elevated temperature, optionally in the presence of the solvent, to inhibit the potential side reaction of Si—H to Si—OH in the presence of water. This may be effected for example by vacuum distillation. Dehydrogenative coupling may be favoured by establishing a weakly acidic medium. In order to make the alcohol to be converted weakly acidic, it is possible for example to add diammonium phosphate (DAP; 100 to 500 ppm) before, during or after distillation.

In a preferred embodiment of the process according to the invention the preferably dried polyether diol (reactant (b)) is heated to reaction temperature and the catalyst added and commixed. The linear α,ω-(SiH)-functional polydialkylsiloxane (reactant (a)) is then added with controlled hydrogen evolution.

In a preferred embodiment of the process according to the invention the preferably dried polyether diol (reactant (b)) is heated to reaction temperature and the catalyst added and commixed. The siloxane (reactant (a)), diluted with a solvent, is then added with controlled hydrogen evolution.

In a preferred embodiment of the process according to the invention the preferably dried polyether diol (reactant (b)) is heated to reaction temperature, diluted with solvent and the catalyst added and commixed. The siloxane (reactant (a)) is then added with controlled hydrogen evolution.

In a preferred embodiment of the process according to the invention the preferably dried polyether diol (reactant (b)) is heated to reaction temperature, diluted with solvent and the catalyst added and commixed. The siloxane (reactant (a)), diluted with a solvent, is then added with controlled hydrogen evolution.

For each of these four abovementioned preferred embodiments the following applies: Addition is preferably effected continuously, thus allowing controlled reaction progress as indicated by corresponding continuous gas liberation. Once gas liberation is complete the reaction is complete, as also demonstrable by sampling and external SiH value determination. In another preferred embodiment the addition of the pure or solvent-diluted siloxane (reactant (a)) in the abovementioned four embodiments may also be performed in each case intervallically instead of continuously.

The siloxane (reactant (a)) is thus then added at intervals. This means that every addition interval is followed by an addition pause which advantageously lasts until a lack of hydrogen evolution indicates quantitative SiH conversion of the previously added portion. This is then followed by the addition of the next interval. It is preferable when the addition amounts and the times per interval are kept constant but those skilled in the art are able to make adjustments in specific applications. Thus initially larger amounts of siloxane may be added per interval at the beginning of the synthesis and smaller amounts towards the end, or vice versa.

It is always highly advantageous to ensure efficient commixing during addition.

According to the invention the reaction of the reactants (a) and (b) proceeds with controlled hydrogen evolution until quantitative SiH conversion. In the context of the present invention this is to be understood as meaning that the difference between the actual conversion and the target conversion is as low as possible, preferably in the range from 0% to 10%, preferably from 0% to 7.5% and particularly preferably from 0% to 5%. The term target conversion is to be understood as meaning the amount of hydrogen that may be liberated upon quantitative SiH conversion of the amount of hydrogen siloxane present in the reaction system at the particular time. The term actual conversion is to be understood as meaning the amount of hydrogen actually liberated at the particular time. This controlled hydrogen evolution may be achieved through controlled addition of component (a) to component (b). If the difference between the target and actual conversion is excessively high for example, the addition rate of component (a) may be throttled. The method for controlling the hydrogen evolution is precisely described in the examples section.

The SiOC-bonded, linear polydialkylsiloxane-polyoxyalkylene block copolymers comprising repeating (AB) units produced by the process according to the invention may particularly advantageously be used as interface-active additives for producing polyurethane foams, in particular for producing mechanically foamed polyurethane foams. This use therefore likewise forms part of the subject matter of the present invention.

Mechanically foamed polyurethane foams are in this connection foams produced without the use of a physical or chemical blowing agent. The production thereof is effected in typical fashion by mechanical foaming of a polyol-isocyanate mixture, wherein air or nitrogen are forced into the reaction mixture with high shear input. The foam material thus produced can then be coated onto any desired substrate, for example a reverse side of a carpet or a release paper, and cured at elevated temperatures. Due to their production, mechanically foamed polyurethane foams are also referred to as beaten foams in specialist circles. The term “beaten foam” is also used for the present invention in exactly that manner.

The present invention further provides a polyurethane foam, preferably beaten polyurethane foam, produced using SiOC-bonded linear polydialkylsiloxane-polyoxyalkylene block copolymers comprising repeating (AB) units which are obtainable by the process according to the invention.

The term “polyurethane foam” in the context of this invention refers to foams which are formed by reacting polyisocyanates with compounds reactive towards them, preferably having OH groups (“polyols”) and/or NH groups (Adam et al., “Polyurethanes”, Ullmann's Encyclopedia of Industrial Chemistry, 2012, Wiley VCH-Verlag, Weinheim). Polyols for producing corresponding foams are known per se. Particularly suitable polyols within the context of this invention are any organic substances having a plurality of isocyanate-reactive groups, and also preparations of said substances. Preferred polyols are any polyether polyols and polyester polyols usually used for the production of polyurethane foams. Polyether polyols are obtainable by reacting polyhydric alcohols or amines with alkylene oxides. Polyester polyols are based on esters of polybasic carboxylic acids (usually phthalic acid, adipic acid or terephthalic acid) with polyhydric alcohols (usually glycols). Preferred polyols further include short-chain diols, for example ethylene glycol, propylene glycol, diethylene glycol or dipropylene glycol, which can be used as chain extenders for example.

Isocyanates for producing polyurethane foams are likewise known per se. The isocyanate component preferably includes one or more organic isocyanates having two or more isocyanate functions. Examples of suitable isocyanates within the context of this invention are any polyfunctional organic isocyanates, for example diphenylmethane 4,4′-diisocyanate (MDI), toluene diisocyanate (TDI), hexamethylene diisocyanate (HMDI) and isophorone diisocyanate (IPDI). Also particularly suitable are isocyanate-based prepolymers, especially MDI-based prepolymers.

Within the scope of the present invention, the ratio of isocyanate to polyol, expressed as the NCO index, is preferably in the range from 40 to 500, more preferably 60 to 350, especially preferably 80-120. The NCO index here describes the ratio of isocyanate actually used to calculated isocyanate (for a stoichiometric reaction with polyol). An NCO index of 100 represents a molar ratio of reactive groups of 1:1.

In the context of the present invention the SiOC-bonded, linear polydialkylsiloxane-polyoxyalkylene block copolymers according to the invention comprising repeating (AB) units are for simplicity also referred to by the term “polydimethylsiloxane-polyether block copolymers” or “polydimethylsiloxane-polyoxyalkylene block copolymers”.

In addition to the polydimethylsiloxane-polyoxyalkylene block copolymers according to the invention, the polyurethanes may also comprise further additives and auxiliaries such as for example fillers, blowing agents, catalysts, organic and inorganic pigments, stabilizers such as for example hydrolysis or UV stabilizers, antioxidants, absorbers, crosslinkers, dyes, emulsifiers or dispersant additives, flow control agents or thickeners/rheology additives.

In the context of the present invention, particularly suitable catalysts for producing polyurethane foams, especially beaten polyurethane foams, are gel catalysts which catalyse the polyurethane reaction between isocyanate and polyol. These may be selected from the class of amine catalysts, for example triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol, tetramethylguanidine, and 1,8-diazabicyclo[5.4.0]undec-7-ene. Furthermore, amine catalysts can be selected from the class of so-called emission-free amine catalysts which are characterized in that they have a catalytically active nitrogen atom and a group reactive towards NCO groups such as, for example, an OH group. Appropriate emission-free amine catalysts are marketed, for example under the product series Dabco® NE from Evonik. In addition, the catalysts can be selected from the class of metal catalysts, for example tin, zinc, bismuth, iron, copper, nickel, or zirconium-based catalysts. Metal catalysts may be present here in the form of salts or of organic derivatives. The catalysts mentioned above can be used either in pure form or as catalyst mixtures. In the case of beaten polyurethane foams, particularly suitable are thermolatent catalysts, i.e. catalysts which only develop their efficacy over and above a certain activation temperature and therefore enable delayed curing of the foams.

It may further be preferable to employ in the production of polyurethane foams, in particular beaten polyurethane foams, not only the polydimethylsiloxane-polyoxyalkylene block copolymers according to the invention but also at least one pendent stabilizer as additional component. Pendent stabilizers here are likewise polyethersiloxanes but have a silicone chain bearing pendent and optionally terminal polyether chains. The polyether chains here may be bonded to the silicone chain either via a silicon-carbon bond (Si—C) or a silicon-oxygen-carbon bond (Si—O—C), particular preference being given to silicon-carbon bonds. Especially preferred here are pendent Si—C-based polyethersiloxanes conforming to general formula (III),

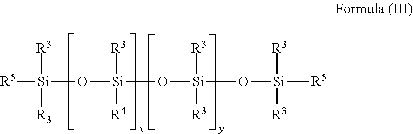

wherein

x=0 to 50, preferably 1 to 25, particularly preferably 2 to 15

y=0 to 250, preferably 5 to 150, particularly preferably 5 to 100

and wherein the radicals R³ are independently at each occurrence identical or different monovalent aliphatic or aromatic hydrocarbon radicals having 1 to 20 carbon atoms, preferably having 1 to 10 carbon atoms, very particularly preferably are methyl radicals, and wherein the radicals R⁴ are independently at each occurrence identical or different OH-functional or terminated, preferably methyl- or acetyl-terminated polyoxyalkylene radicals, preferably polyoxyethylene-polyoxypropylene radicals, and wherein the radicals R⁵ correspond to either R³ or R⁴.

In the context of the present invention, the polyurethane foams are preferably beaten polyurethane foams which are produced by mechanically beating the polyol-isocyanate mixture. Such beaten foams preferably contain less than 2% by weight, more preferably less than 1% by weight, especially preferably less than 0.5% by weight, most preferably less than 0.1% by weight of a chemical or physical blowing agent. The polyurethane foams especially preferably comprise no physical or chemical blowing agent.

As described hereinabove the use of the polydimethylsiloxane-polyoxyalkylene block copolymers according to the invention for producing polyurethane beaten foams forms a particularly preferred part of the subject matter of the present invention. Preferably, such beaten polyurethane foams can be produced by a process comprising the steps of
a) providing a polyol component, an isocyanate component, at least one polydimethylsiloxane-polyoxyalkylene block copolymer according to the invention and optionally further additives
b) mixing all components to afford a homogeneous mixture
c) mechanically foaming the mixture while introducing a gas, for example air or nitrogen, to afford a (preferably homogeneous, fine-celled) foam
d) applying the foamed reaction mixture to a substrate
e) curing the foamed reaction mixture.

It is made clear that the process steps of this process as set out above are not subject to any fixed sequence in time. For instance, process steps b) and c) can be carried out simultaneously, meaning that individual components are added to and mixed with the reaction mixture only during the foaming procedure. Individual additives, such as the catalyst for example, can also be added only after process step c) to the mechanically foamed reaction mixture.

It is a preferred embodiment of the present invention when, in process step c), the reaction mixture of polyol, isocyanate and optionally further additives is foamed by the application of high shear forces. The foaming can be effected here with the aid of shear units familiar to the person skilled in the art, for example Dispermats, dissolvers, Hansa mixers or Oakes mixers.

It is additionally preferable if the mechanically foamed reaction mixture after process step c) has a density in the range of 50-1000 g/L, preferably in the range of 75-600 g/L, more preferably in the range of 100-450 g/L.

In process step d), the reaction mixture can be applied to virtually any desired substrate, for example carpet backings, the backings of synthetic turf, adhesive coatings, textile carrier webs, release papers or release films, and also to metals, either to be left on the metal permanently or for later removal of the cured reaction mixture.

It is additionally preferable when, in process step e), the foamed reaction mixture is cured at elevated temperatures. Preference is given here in accordance with the invention to curing temperatures of at least 50° C., preferably of 60° C., more preferably of at least 70° C.

The invention further provides for the use of a polyurethane foam according to the invention, preferably beaten PU foam, as described above, for production of floor coverings such as carpets, footfall sound insulation or synthetic turf, and for production of textile coatings or of sealing materials, gap fillers, shock pads or compression pads.

### EXPERIMENTAL SECTION

Methods of Measurement:

In the context of the present invention, parameters or measurements are preferably determined using the methods described hereinbelow. These methods were in particular used in the examples of the present intellectual property right.

The SiH conversion of the dehydrogenative coupling is determined by butoxide-catalysed liberation of the (residual) SiH present in the sample as elementary hydrogen and quantitative determination thereof.

In the context of the present invention weight-average and number-average molecular weights are determined for the produced SiOC-bonded, linear polydialkylsiloxane-polyoxyalkylene block copolymers calibrated against a polystyrene standard by gel permeation chromatography (GPC). In the following examples the polydispersity index (PDI) is reported as a further characteristic parameter for describing molecular weight distribution. GPC was performed using a PSS SECurity 1260 (Agilent 1260) fitted with an RI detector and an SDV 1000/10000 Å column combination consisting of an 0.8×5 cm pre-column and two 0.8×30 cm main columns at a temperature of 30° C. and a flow rate of 1 mL/min (mobile phase: THF). The sample concentration was 10 g/l and the injection volume was 20 μl.

Wet chemistry analysis was performed according to international standard methods: iodine value (IV; DGF C-V 11 a (53); acid value (AV; DGF C-V 2); OH value (OHV; ASTM D 4274 C).

Description of Method for Controlling Hydrogen Evolution

The process according to the invention has the feature that the two reactants (a) and (b) preferably in equimolar amounts and with controlled hydrogen evolution are reacted to quantitative SiH conversion, wherein in particular reactant (b) is initially charged and reactant (a) is added. The term “controlled hydrogen evolution” especially provides that the rate of addition of the component (a) to (b) is effected such that the difference between the actual conversion and the target conversion is preferably in the range from 0% to 10%, preferably from 0% to 7.5% and particularly preferably from 0% to 5%.

The method for controlling the hydrogen evolution is as follows:

The reaction is performed in a 1000 ml ground-glass four-necked flask fitted with a stainless steel Sigma Stirrer®, internal thermometer and a reflux cooler with a gas discharge hose. The heating medium is a standard heating mantle controlled with a PID Fuzzy Logic to establish the target temperature. The siloxane to be added (=component (a)) is aspirated using a peristaltic pump via a reservoir vessel placed on a tared balance and transferred into the ground glass flask.

The gas discharge hose of the ground glass flask passes via a transition piece with an olive into a gas tightly sealed 4 litre 2-necked flask which is filled with boiled gas-free water with zero dead volume. The 2-necked flask is further provided with a gas inlet tube with an olive which extends to just above the flask bottom. The 2-necked flask is placed on a tared balance.

Starting the siloxane addition immediately causes the reaction to set in and the resulting gas which generates a volume expansion in the overall system is transferred into the two-necked flask. This in turn has the result that the water content is expelled from the flask via the inlet tube and is collected in a further collection vessel.

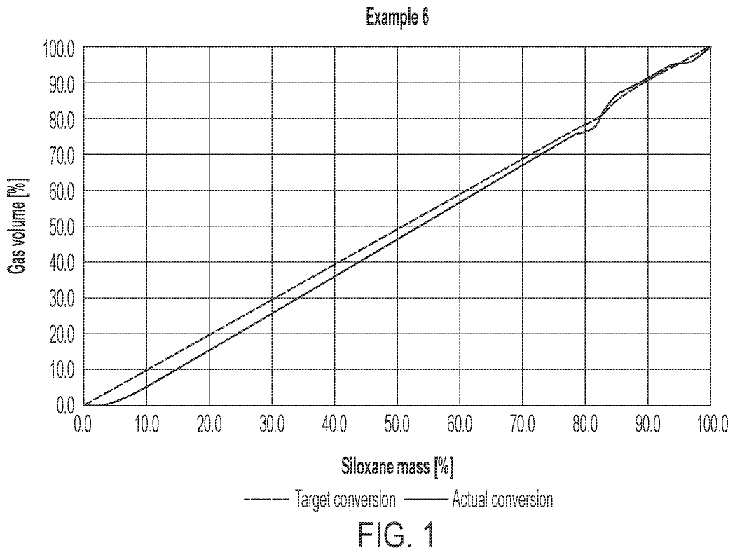

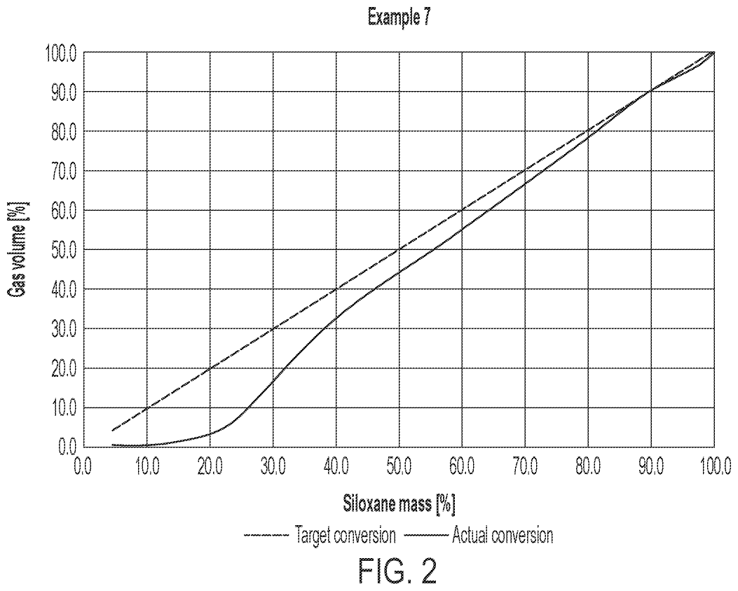

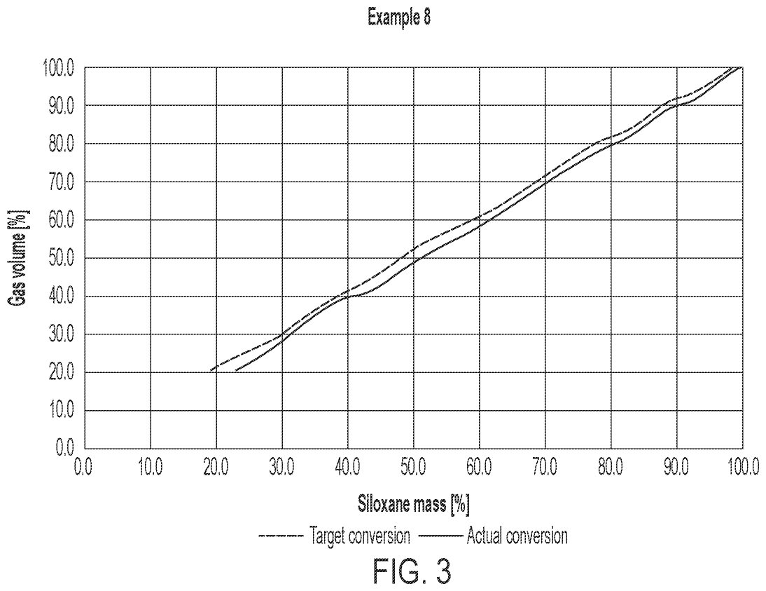

Continuous data capture of the individual masses via differential weighing of the siloxane and of the 2-necked flask makes it possible to identify the rate of reaction of the two reactants (a) and (b) to afford the product. This is done by plotting data pairs of the masses of the siloxane reservoir flask and of the 2-necked flask. The mass of the added siloxane may be used to calculate the theoretical gas volume that would be occupied by the liberated hydrogen (by-product) of the condensation reaction at this time. The target conversion of the respective reaction system may therefore be calculated over the entire course of the reaction. This is shown as a dashed line in FIGS. 1 to 3.

Using the mass of the displaced water and with the aid of the density of the water at a particular temperature, the actual evolved gas volume may be determined. Using the gas laws for ideal gases, the gas volume is converted to standard conditions. The actual conversion of the respective reaction system may therefore be determined over the entire course of the reaction. This is shown as a solid line in FIGS. 1 to 3.

The quotient of actually evolved gas volume and theoretical gas volume describes the degree of conversion of the reaction at this time.

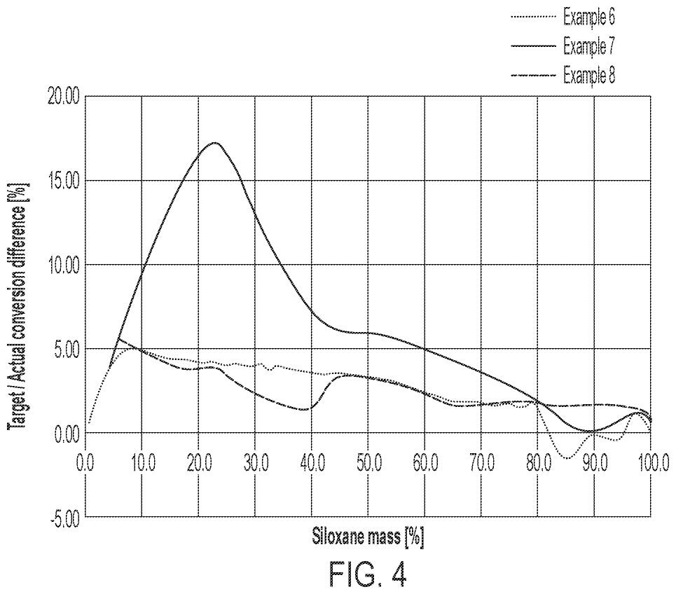

As is apparent from the following inventive examples and the figure FIG. 4, it is very particularly preferred according to the invention when the rate of siloxane addition is chosen such that the difference between the “actual conversion” and the “target conversion” is preferably in the range from 0% to 10%, preferably from 0% to 7.5% and particularly preferably from 0% to 5%. This preferably applies above a siloxane addition amount of 10% of the total amount to be added and particularly preferably above 5% of the total amount to be added. Those skilled in the art can in this way through simple bench experiments rapidly establish an optimal siloxane addition rate and thus realize an optimally controlled hydrogen evolution.

### Example 1 (Inventive)

A 1000 mL ground glass four-necked flask provided with a stainless steel Sigma Stirrer®, an addition unit with a peristaltic pump, an internal thermometer and a reflux cooler with a gas discharge hose is initially charged with 282.1 g of a dried polyoxyalkylene diol having a water content of <0.02%. The polyoxyalkylene diol having an average molar weight of 2800 g/mol (determined via OH number) and an ethylene oxide/propylene oxide ratio of about 1:1 is combined with 378.0 g of a linear alkylbenzene having a boiling range of about 240° C. to 314° C. The mixture is heated to a temperature of 105° C. 179.0 mg of tris(pentafluorophenyl)borane (450 ppm based on the total amount of the reactants) dissolved in 20 g of the above-described alkylbenzene are then added. After a stirring time of 5 minutes 115.6 g of an α,ω-hydrogen siloxane (average chain length N=15, i.e. consisting of 15 Si units) are added in an equimolar ratio to the employed polyoxyalkylenediol. The addition amount and rate are adjusted using a programmable peristaltic pump such that the total amount of the hydrogen siloxane is divided into about 18 individual intervals of 6.4 g each. The actual addition duration of 1 minute is immediately followed by a pause in addition of 8 minutes. This procedure is repeated in the same way for all 18 intervals. After addition of the stoichiometric siloxane amount a marked viscosity increase is observed. The end of the reaction is unambiguously discernible from the weakening gas evolution. Gas-volumetric SiH determination demonstrates complete conversion. A colourless high-viscosity product having a viscosity of 330 000 mPa s and a weight-average molecular weight of M_{w} 105 000 g/mol and a PDI of 2.24 is obtained.

### Example 2 (Inventive)

A 1000 mL ground glass four-necked flask provided with a stainless steel Sigma Stirrer®, an addition unit with a peristaltic pump, an internal thermometer and a reflux cooler with a gas discharge hose is initially charged with 278.3 g of a dried polyoxyalkylene diol having a water content of <0.02%. The polyoxyalkylene diol having an average molar weight of 2800 g/mol (determined via OH number) and an ethylene oxide/propylene oxide ratio of about 1:1 is combined with 194.0 g of a linear alkylbenzene having a boiling range of about 240° C. to 314° C. The mixture is heated to a temperature of 105° C. 260.0 mg of tris(pentafluorophenyl)borane (670 ppm based on the total amount of the reactants) dissolved in 20 g of the above-described alkylbenzene are then added. After a stirring time of 5 minutes 300.0 g of a mixture of an α,ω-hydrogen siloxane (average chain length N=15, i.e. consisting of 15 Si units) and a linear alkylbenzene having a siloxane proportion of 36.5% by weight are added in an equimolar ratio to the employed polyoxyalkylenediol. The addition amount and rate are adjusted using a programmable peristaltic pump such that the total amount of the added mixture is divided into about 18 individual intervals of 16.7 g each. The actual addition duration of 2 minutes is immediately followed by a pause in addition of 10 minutes. This procedure is repeated in the same way for all 18 intervals. After addition of the stoichiometric siloxane amount a marked viscosity increase is observed. The end of the reaction is unambiguously discernible from the weakening gas evolution. Gas-volumetric SiH determination demonstrates complete conversion. A colourless high-viscosity product having a viscosity of 45 600 mPa s is obtained.

### Example 3 (Inventive)

A 1000 mL ground glass four-necked flask provided with a stainless steel Sigma Stirrer®, an addition unit with a peristaltic pump, an internal thermometer and a reflux cooler with a gas discharge hose is initially charged with 282.1 g of a dried polyoxyalkylene diol having a water content of <0.02%. The polyoxyalkylene diol having an average molar weight of 2800 g/mol (determined via OH number) and an ethylene oxide/propylene oxide ratio of about 1:1 is combined with 378.0 g of a linear alkylbenzene having a boiling range of about 240° C. to 314° C. The mixture is heated to a temperature of 105° C. 218.7 mg of tris(pentafluorophenyl)borane (550 ppm based on the total amount of the reactants) dissolved in 20 g of the above-described alkylbenzene are then added. After a stirring time of 5 minutes 115.6 g of an α,ω-hydrogen siloxane (average chain length N=15, i.e. consisting of 15 Si units) are added in an equimolar ratio to the employed polyoxyalkylenediol. The addition amount and rate are adjusted using a programmable peristaltic pump such that the total amount of the hydrogen siloxane is added continuously over 245 minutes. After addition of the stoichiometric siloxane amount a marked viscosity increase is observed. The end of the reaction is unambiguously discernible from the weakening gas evolution. Gas-volumetric SiH determination demonstrates complete conversion. A colourless high-viscosity product having a viscosity of 250 000 mPa s and a weight-average molecular weight of M_{w} 161 000 g/mol and a PDI of 2.89 is obtained.

### Example 4 (Non-Inventive)

A 1000 mL ground glass four-necked flask provided with a stainless steel Sigma Stirrer®, an addition unit with a peristaltic pump, an internal thermometer and a reflux cooler with a gas discharge hose is initially charged with 282.1 g of a dried polyoxyalkylene diol having a water content of <0.02%. The polyoxyalkylene diol having an average molar weight of 2800 g/mol (determined via OH number) and an ethylene oxide/propylene oxide ratio of about 1:1 is combined with 178.6 g of a linear alkylbenzene having a boiling range of about 240° C. to 314° C. The mixture is heated to a temperature of 105° C. 268.0 mg of tris(pentafluorophenyl)borane (675 ppm based on the total amount of the reactants) dissolved in 20 g of the above-described alkylbenzene are then added. After a stirring time of 5 minutes 315.0 g of a mixture of an α,ω-hydrogen siloxane (average chain length N=15, i.e. consisting of 15 Si units) and a linear alkylbenzene having a siloxane proportion of 36.5% by weight are added in an equimolar ratio to the employed polyoxyalkylenediol. The addition amount and rate are adjusted using a programmable peristaltic pump such that the total amount of the added mixture is divided into about 9 individual intervals of 35.0 g each. The actual addition duration of 1 minute is immediately followed by a pause in addition of 10 minutes. This procedure is repeated in the same way for all 9 intervals. After addition of the stoichiometric siloxane amount a marked viscosity increase is observed. The end of the reaction is unambiguously discernible from the weakening gas evolution. Gas-volumetric SiH determination demonstrates complete conversion. A colourless viscous product having a viscosity of 11 500 mPa s is obtained.

### Example 5 (Non-Inventive)

A 1000 mL ground glass four-necked flask provided with a stainless steel Sigma Stirrer®, an addition unit with a peristaltic pump, an internal thermometer and a reflux cooler with a gas discharge hose is initially charged with 176.7 g of a dried polyoxyalkylene diol having a water content of <0.02%. The polyoxyalkylene diol having an average molar weight of 2800 g/mol (determined via OH number) and an ethylene oxide/propylene oxide ratio of about 1:1 is combined with 258.2 g of a linear alkylbenzene having a boiling range of about 240° C. to 314° C. The mixture is heated to a temperature of 105° C. 231.4 mg of tris(pentafluorophenyl)borane (521 ppm based on the total amount of the reactants) dissolved in 20 g of the above-described alkylbenzene are then added. After a stirring time of 5 minutes 101.5 g of an α,ω-hydrogen siloxane (average chain length N=15, i.e. consisting of 15 Si units) are added in an excess ratio of 1.45:1.0 to the employed polyoxyalkylenediol. The addition amount and rate are adjusted using a programmable peristaltic pump such that the total amount of the hydrogen siloxane is added continuously over 40 minutes. After addition of the stoichiometric siloxane amount a marked viscosity increase is observed. From the time at which the siloxane excess is added to the system, a viscosity decrease with accompanying clouding of the product is observable. Gas evolution is also likewise markedly reduced from this time. Gas-volumetric SiH determination verifies a conversion of 100% based on the employed siloxane mass. A slightly cloudy product having a viscosity of 1300 mPa s and a weight-average molecular weight of M_{w} 58 000 g/mol and a PDI of 3.55 is obtained.

### Example 6 (Inventive)

A 1000 mL ground glass four-necked flask provided with a stainless steel Sigma Stirrer®, an addition unit with a peristaltic pump, an internal thermometer and a reflux cooler with a gas discharge hose is initially charged with 176.7 g of a dried polyoxyalkylene diol having a water content of <0.02%. The polyoxyalkylene diol having an average molar weight of 2800 g/mol (determined via OH number) and an ethylene oxide/propylene oxide ratio of about 1:1 is combined with 226.7 g of a linear alkylbenzene having a boiling range of about 240° C. to 314° C. The mixture is heated to a temperature of 105° C. 160.0 mg of tris(pentafluorophenyl)borane (650 ppm based on the total amount of the reactants) dissolved in 20 g of the above-described alkylbenzene are then added. After a stirring time of 5 minutes 70.0 g of an α,ω-hydrogen siloxane (average chain length N=15, i.e. consisting of 15 Si units) are added in an equimolar ratio to the employed polyoxyalkylenediol. The addition amount and rate are adjusted using a programmable peristaltic pump such that the total amount of the hydrogen siloxane is added continuously over 190 minutes. After addition of the stoichiometric siloxane amount a marked viscosity increase is observed. The end of the reaction is unambiguously discernible from the weakening gas evolution. Gas-volumetric SiH determination demonstrates complete conversion. A colourless high-viscosity product having a viscosity of 125 000 mPa s and a weight-average molecular weight of M_{w} 183 500 g/mol and a PDI of 4.58 is obtained.

### Example 7 (Non-Inventive)

A 1000 mL ground glass four-necked flask provided with a stainless steel Sigma Stirrer®, an addition unit with a peristaltic pump, an internal thermometer and a reflux cooler with a gas discharge hose is initially charged with 176.7 g of a dried polyoxyalkylene diol having a water content of <0.02%. The polyoxyalkylene diol having an average molar weight of 2800 g/mol (determined via OH number) and an ethylene oxide/propylene oxide ratio of about 1:1 is combined with 226.7 g of a linear alkylbenzene having a boiling range of about 240° C. to 314° C. The mixture is heated to a temperature of 105° C. 160.0 mg of tris(pentafluorophenyl)borane (650 ppm based on the total amount of the reactants) dissolved in 20 g of the above-described alkylbenzene are then added. After a stirring time of 5 minutes 70.0 g of an α,ω-hydrogen siloxane (average chain length N=15, i.e. consisting of 15 Si units) are added in an equimolar ratio to the employed polyoxyalkylenediol. The addition amount and rate are adjusted using a programmable peristaltic pump such that the total amount of the hydrogen siloxane is added continuously over 25 minutes. After addition of the stoichiometric siloxane amount a marked viscosity increase is observed. The end of the reaction is unambiguously discernible from the weakening gas evolution. Gas-volumetric SiH determination demonstrates complete conversion. A colourless high-viscosity product having a viscosity of 77 000 mPa s and a weight-average molecular weight of M_{w} 144 900 g/mol and a PDI of 3.41 is obtained.

### Example 8 (Inventive)

A 1000 mL ground glass four-necked flask provided with a stainless steel Sigma Stirrer®, an addition unit with a peristaltic pump, an internal thermometer and a reflux cooler with a gas discharge hose is initially charged with 176.7 g of a dried polyoxyalkylene diol having a water content of <0.02%. The polyoxyalkylene diol having an average molar weight of 2800 g/mol (determined via OH number) and an ethylene oxide/propylene oxide ratio of about 1:1 is combined with 226.7 g of a linear alkylbenzene having a boiling range of about 240° C. to 314° C. The mixture is heated to a temperature of 105° C. 160.0 mg of tris(pentafluorophenyl)borane (650 ppm based on the total amount of the reactants) dissolved in 20 g of the above-described alkylbenzene are then added. After a stirring time of 5 minutes 70.0 g of an α,ω-hydrogen siloxane (average chain length N=15, i.e. consisting of 15 Si units) are added in an equimolar ratio to the employed polyoxyalkylenediol. The addition amount and rate are adjusted using a programmable peristaltic pump such that the total amount of the hydrogen siloxane is divided into about 11 individual intervals of 6.4 g each. The actual addition duration of 12 minutes is immediately followed by a pause in addition of 3 minutes. This procedure is repeated in the same way for all 11 intervals. After addition of the stoichiometric siloxane amount a marked viscosity increase is observed. The end of the reaction is unambiguously discernible from the weakening gas evolution. Gas-volumetric SiH determination demonstrates complete conversion. A colourless high-viscosity product having a viscosity of 79 000 mPa s and a weight-average molecular weight of M_{w} 131 200 g/mol and a PDI of 3.23 is obtained.

Drawings FIG. 1 to FIG. 4

The drawings FIG. 1 to FIG. 4 elucidate the examples 6 to 8 of the invention. The drawings FIG. 1 to FIG. 3 in each case show the liberated hydrogen volume as a function of the added hydrogen siloxane amount for the three examples 6 to 8. The experiments differ in terms of the addition type (continuous or interval) and/or the addition rate as described hereinabove. The dashed line in each case indicates the target conversion. The solid line in each case indicates the actual conversion.

FIG. 4 shows a summary of the influence of reaction management on the difference between target and actual conversion as a function of added siloxane mass for the examples 6 to 8.

Polyurethane Formulation:

To assess the efficacy of the polyether-siloxane block copolymers produced in Examples 1-8 as stabilizer for the production of beaten polyurethane foams, a series of test foamings was conducted. These were done using the polyurethane formulation described in the table:

TABLE 1
Overview of formulation used in foaming experiments.

| | Manufac- | | |
|---|---|---|---|
| | turer/ | | Parts by |
| Polyol | supplier | Composition | weight |
| Voranol ® CP | Dow | EO/PO polyether polyol | 140 |
| 3322 | | OHN = 48 mg KOH/g; | |
| | | f ≈ 3 | |
| Voralux ® HN | Dow | SAN polymer polyether | 60 |
| 360 | | polyol OHN = 30 mg | |
| | | KOH/g, f ≈ 3 | |
| DPG | Sigma | Dipropylene glycol | 30 |
| | Aldrich | OHN = 836 mg KOH/g, f = 2 | |
| KOSMOS ® N | Evonik | Nickel(II) acetylacetonate | 4 |
| 200 | | catalyst | |
| Stabilizer | | From Example 1-8 | 4 |
| Omya ® BLS | Omya | CaCO3 filler | 0 or 230 |
| | GmbH | | |
| Suprasec ® 6505 | Huntsman | Polymeric MDI | 92 |
| | | NCO % = 29.3% | Index = |
| | | | 105 |

### Example 9: Manual Foaming

The effectiveness of the polyether siloxane block copolymers as a stabilizer for beaten PU foams was initially investigated in manual foaming tests. These were performed using a dissolver, Dispermat® LC75 model from VMA-Getzman, equipped with a dissolver disc, Ø=6 cm. For these experiments the polyol formulation described in table 1 was used without filler. First polyols, stabilizer and catalyst in the appropriate ratio were weighed into a 1000 ml plastic beaker and stirred for 3 minutes at about 500 rpm to afford a homogeneous mixture. Isocyanate was then added and the mixture was foamed for 3 minutes at 2200 rpm. Care was taken here that the dissolver disc was always immersed sufficiently into the mixture that a proper vortex was formed. The volume increase of the produced foam was then measured. This was used as an evaluation criterion for the effectiveness of the foam stabilizers. The measured values are summarized in table 2.

As is apparent from this composition, considerably greater volume increases were achievable with the polydimethylsiloxane-polyoxyalkylene block copolymers produced by the process according to the invention; the polyol-isocyanate mixture was thus able to be beaten much more efficiently.

TABLE 2
Results of manual foaming

| Stabilizer | Foam volume increase [ml] |
|---|---|
| from inventive example 1 | 167 |
| from inventive example 2 | 158 |
| from inventive example 3 | 150 |
| from non-inventive example 4 | 67 |
| from non-inventive example 5 | 0 |
| from inventive example 6 | 133 |
| from non-inventive example 7 | 115 |
| from inventive example 8 | 133 |

### Example 10: Machine Foaming

Additional experiments for further evaluation of the effectiveness of the polyether-siloxane block copolymers as stabilizers for beaten PU foams were performed with a fully automated laboratory foam generator of the type Pico-Mix XL from Hansa-Mixer, equipped with 2 separate eccentric screw hopper pumps. For these experiments the polyol formation described in table 1 was this time used with filler. To this end a premixture (batch size about 5 kg) of polyols, stabilizer, catalyst and calcium carbonate was produced and then filled into one of the two hopper pumps of the foam generator. The other hopper pump was filled with the isocyanate component. For the foaming experiments, polyol premixture and isocyanate were simultaneously injected into the mixing head of the foam generator and foamed therein by simultaneous introduction of air. The mixing head was operated here at 850 rpm in all experiments. The delivery rates of both hopper pumps were constantly adjusted such that polyol and isocyanate were injected into the mixing head in the appropriate ratio (corresponding to the NCO index of the formulation), with a total mass flow of 9 kg/h. The air flow into the mixing head was selected so as to obtain foam densities of 250 and 300 g/l after foaming.

The homogeneity and stability of the foam obtained on discharge from the mixing head were an evaluation criterion for the efficacy of the foam stabilizer. The foamed reaction mixture was then painted (layer thickness 6 mm) onto a coated release paper using a laboratory coating table/dryer, Labcoater LTE-S from Mathis AG, and cured at 120° C. for 15 minutes. Cell structure and cell homogeneity of the cured foam were a further evaluation criterion for the effectiveness of the foam stabilizer.

As is apparent from the composition in table 3, foams comprising polydimethylsiloxane-polyoxyalkylene block copolymers produced by the process according to the invention exhibit improved foam stability and a finer and more homogeneous cell structure. By contrast, the non-inventive stabilizers resulted in quite coarse and irregular foams having reduced stability, which was manifested, for example, by coarser cells as the foams cured. It should especially be noted that the non-inventive foam stabilizer from example 5 initially did not even allow the production of beaten foams in the desired density range. In this case complete foam collapse directly after discharge from the mixing head was observed. Curing afforded a compact mass which comprised only a few coarse air inclusions. The foaming results thus clearly demonstrate the improved efficacy of the foam stabilizers produced by the process according to the invention.

TABLE 3
Results of machine foaming

| | |
|---|---|
| 250 g/l | 300 g/l |

Polydimethylsiloxane-polyoxyalkylene block copolymer
(inventive example 1)

| | | |
|---|---|---|
| Foam stability | + | ++ |
| Foam homogeneity | ++ | ++ |

Polydimethylsiloxane-polyoxyalkylene block copolymer
(inventive example 2)

| | | |
|---|---|---|
| Foam stability | + | ++ |
| Foam homogeneity | + | ++ |

Polydimethylsiloxane-polyoxyalkylene block copolymer
(inventive example 3)

| | | |
|---|---|---|
| Foam stability | ++ | + |
| Foam homogeneity | + | ++ |

Polydimethylsiloxane-polyoxyalkylene block copolymer
(non-inventive example 4)

| | | |
|---|---|---|
| Foam stability | −− | − |
| Foam homogeneity | −− | − |

Polydimethylsiloxane-polyoxyalkylene block copolymer
(non-inventive example 5)

| | |
|---|---|
| Foam stability | Complete foam collapse - |
| Foam homogeneity | evaluation impossible |

Polydimethylsiloxane-polyoxyalkylene block copolymer
(inventive example 6)

| | | |
|---|---|---|
| Foam homogeneity | + | + |
| Foam stability | + | ++ |

Polydimethylsiloxane-polyoxyalkylene block copolymer
(non-inventive example 7)

| | | |
|---|---|---|
| Foam stability | − | ∘ |
| Foam homogeneity | − | ∘ |

Polydimethylsiloxane-polyoxyalkylene block copolymer
(inventive example 8)

| | | |
|---|---|---|
| Foam stability | + | ++ |
| Foam homogeneity | + | + |

(rating from −− = very poor, through ∘ = average to ++ = very good)

1-16. (canceled)

17. A process for producing SiOC-bonded, linear polydialkylsiloxane-polyoxyalkylene block copolymers comprising repeating (AB) units, the process comprising reacting a linear, α,ω-(SiH)-functional polydialkylsiloxane (a) with a linear α,ω-(OH)-functional polyoxyalkylene (b) using one or more compounds of elements of main group III and/or the 3rd transition group as catalyst, the reaction proceeding with controlled hydrogen evolution until quantitative SiH conversion.

18. The process of claim 17, wherein the reaction takes place in the presence of a solvent (d), and wherein the two reactants (a) and (b) are in equimolar amounts.

19. The process of claim 17, wherein the linear α,ω-(SiH)-functional polydialkylsiloxane conforms to general formula (I):
M′-Dₐ-M′ Formula (I),
wherein:
M′=[HR¹₂SiO_{1/2}];
D=[R¹₂SiO_{2/2}];
a=8-100;
R¹=independently at each occurrence, identical or different hydrocarbon radicals having 1-20 carbon atoms.

20. The process of claim 17, wherein the linear α,ω-(OH)-functional polyoxyalkylene conforms to formula (II):
HO—(CₙH₍₂ₙ₋ₘ₎R²ₘO—)_{b}—H Formula (II),
b=1-200;
n=2-4;
m=0 or 1;
R²=independently at each occurrence, identical or different hydrocarbon radicals having 1-12 carbon atoms.

21. The process of claim 17, wherein oxyalkylene units in the linear α,ω-(OH)-functional polyoxyalkylene comprise oxyethylene units and/or oxypropylene units.

22. The process of claim 17, wherein the molar ratio of the two reactants (a) to (b) is in the range of 0.9 to 1.10.

23. The process of claim 17, wherein:
the process is performed in the presence of solvent;
the reactants (a) and/or (b) are mixed with solvents;
the total solvent proportion based on the total amount of reactants (a) and (b) and solvent is between 40% by weight and 70% by weight.

24. The process of claim 17, wherein the reaction is carried out such that reactant (b) is initially charged and reactant (a) is added, wherein the addition may be performed continuously or intervallically.

25. The process of claim 17, wherein the reaction is carried by a procedure selected from the group consisting of:
(i) reactant (b) is heated to reaction temperature, catalyst is added and commixed and reactant (a) is then added with controlled hydrogen evolution;
(ii) reactant (b) is heated to reaction temperature, catalyst is added and commixed, and reactant (a), diluted with solvent, is then added with controlled hydrogen evolution;
(iii) reactant (b) is heated to reaction temperature, diluted with solvent, catalyst is added and commixed, and reactant (a) is then added with controlled hydrogen evolution; and
(iv) reactant (b) is heated to reaction temperature, diluted with solvent, catalyst is added and commixed, and reactant (a), diluted with solvent, is then added with controlled hydrogen evolution.

26. The process of claim 17, wherein the reaction temperature for producing the SiOC-bonded, linear polydialkylsiloxane-polyoxyalkylene block copolymers having repeating (AB) units is in the range of 60° C. to 140° C.

27. The process of claim 17, wherein:
as compounds of elements of main group III, the process employs a boron-containing and/or aluminium-containing catalyst; and
as compounds of elements of the 3rd transition group, the process employs a scandium-containing, yttrium-containing, lanthanum-containing and/or lanthanoid-containing catalyst.

28. The process of claim 27, wherein catalyst is employed in amounts of 0.01% to 0.2% by weight based on the sum of the amount of reactants (a) and (b).

29. The process of claim 17, wherein, in order to control hydrogen evolution, the rate of addition of component (a) to (b) is provided such that the difference between the actual conversion and the target conversion is in the range from 0% to 10%.

30. The process of claim 20, wherein the linear α,ω-(SiH)-functional polydialkylsiloxane conforms to general formula (I):
M′-Dₐ-M′ Formula (I),
wherein:
M′=[HR¹₂SiO_{1/2}];
D=[R¹₂SiO_{2/2}];
a=8-100;
R¹=independently at each occurrence, identical or different hydrocarbon radicals having 1-20 carbon atoms.

31. The process of claim 30, wherein the linear α,ω-(OH)-functional polyoxyalkylene conforms to formula (II):
HO—(CₙH₍₂ₙ₋ₘ₎R²ₘO—)_{b}—H Formula (II),
b=1-200;
n=2-4;
m=0 or 1;
R²=independently at each occurrence, identical or different hydrocarbon radicals having 1-12 carbon atoms.

32. The process of claim 31, wherein the reaction is carried by a procedure selected from the group consisting of:
(i) reactant (b) is heated to reaction temperature, catalyst is added and commixed and reactant (a) is then added with controlled hydrogen evolution;
(ii) reactant (b) is heated to reaction temperature, catalyst is added and commixed, and reactant (a), diluted with solvent, is then added with controlled hydrogen evolution;
(iii) reactant (b) is heated to reaction temperature, diluted with solvent, catalyst is added and commixed, and reactant (a) is then added with controlled hydrogen evolution; and
(iv) reactant (b) is heated to reaction temperature, diluted with solvent, catalyst is added and commixed, and reactant (a), diluted with solvent, is then added with controlled hydrogen evolution.

33. The process of claim 32, wherein:
as compounds of elements of main group III, the process employs a boron-containing and/or aluminium-containing catalyst; and
as compounds of elements of the 3rd transition group, the process employs a scandium-containing, yttrium-containing, lanthanum-containing and/or lanthanoid-containing catalyst.

34. A SiOC-bonded, linear polydialkylsiloxane-polyether block copolymer comprising repeating (AB) units produced by the process of claim 17.

35. The block copolymer of claim 34, wherein the entire siloxane block portion (A) is between 20% and 50% by weight, and the polyoxyalkylene block portion (B) is between 80% and 50% by weight, based on the total block copolymer, wherein the block copolymer has a weight-average molecular weight, M_{w}, of 10,000 g/mol to 250,000 g/mol, as determinable by GPC.

36. A beaten polyurethane foam comprising the block copolymer of claim 34 as an interface-active additive.
